(19) United States
(12) Patent Application Publication
(10) Pub. No.: US 2002/0178701 A1
(43) Pub. Date: Dec. 5, 2002

(54) Cyclone dust collecting apparatus for a vacuum cleaner

(76) Inventors: Jang-keun Oh, Gwangju-city (KR); Min-jo Choi, Gwangju-city (KR)

Correspondence Address: LADAS & PARRY, 224 SOUTH MICHIGAN AVENUE, SUITE 1200, CHICAGO, IL, 60604, US

(21) Appl. No.: 10/083,086

(22) Filed: Feb. 26, 2002

(30) Foreign Application Priority Data
May 31, 2001 (KR) 2001-30252

(51) Int. Cl. B01D 50/00

(52) U.S. Cl. 55/337; 55/426

(57) ABSTRACT

A cyclone dust-collecting apparatus for a vacuum cleaner includes: a cyclone body for separating filth from air drawn through an air-suction passage and for discharging cleaned air through an air-discharging passage; and a filth backflow-preventing member for shifting an advancing direction of the filth in the air flowing to the air-discharging passage to a whirling air current along an inner side of the cyclone body. The cyclone dust-collecting apparatus is capable of improving the dust-collecting function of the vacuum cleaner by preventing filth, which may not have been separated from the whirling air current, from being drawn to a vacuum-generating device of the vacuum cleaner.

### BACKGROUND OF THE INVENTION

1. Field of the Invention

The present invention relates to a cyclone dust-collecting apparatus for a vacuum cleaner, and more particularly to a cyclone dust-collecting apparatus that forms a whirling air current from drawn air and separates filth from the air by centrifugal force.

2. Description of the Related Art

FIG. 1 shows one example of a conventional cyclone dust-collecting apparatus for a vacuum cleaner. According to FIG. 1, conventional cyclone dust-collecting apparatus 10 for the vacuum cleaner includes cyclone body 20, filth-collecting portion 30, and partition 40.

Air-suction passage 21, connected to a brush assembly (not shown) of the vacuum cleaner, is disposed at an upper part of cyclone body 20. The air drawn through airsuction passage 21 forms a whirling air current as it is drawn in a tangential direction to cyclone body 20.

Air-discharging passage 22, connected to a vacuum-generating device (not shown), is disposed at an upper center part of cyclone body 20. Grill 23 is disposed at an inlet of air-discharging passage 22 for preventing filth, such as hair, from being drawn into the vacuum-generating device.

Filth-collecting portion 30 is usually removably formed at a lower part of cyclone body 20 for easy removal of filth that has been separated and collected by cyclone body 20.

Partition 40 is disposed between cyclone body 20 and filth-collecting portion 30. Filth-discharging passage 41 is formed at one side of partition 40 for guiding the filth separated by cyclone body 20.

For the conventional cyclone dust-collecting apparatus 10 of a vacuum cleaner with the above construction, the air containing filth from a cleaning surface is drawn into cyclone body 20 through air-suction passage 21 when the vacuum-generating device of the vacuum cleaner is operated.

The air, drawn into cyclone body 20, forms a whirling air current. Filth contained in the air is separated by centrifugal force of the whirling current and collected in filth-collecting portion 30 through filth-discharging passage 41. The cleaned air is discharged through air-discharging passage 22.

On the other hand, filth that has not been separated from the air passes through grill 23 with the air. The filth, which has passed through, flows with the air through air-discharging passage 22 to the vacuum-generating device which may include a filter in the upper part.

The filth is separated from the air in the filter, and the cleaned air is discharged outside of the vacuum cleaner through the vacuum-generating device. Meanwhile, the filth can clog the filter and deteriorate the dust-collecting function of the vacuum cleaner.

### SUMMARY OF THE INVENTION

An embodiment includes a cyclone dust-collecting apparatus of a vacuum cleaner capable of improving the dust-collecting function of the vacuum cleaner by preventing filth, which has not been separated from the air by the centrifugal force of a whirling air current, from being drawn to a vacuum-generating device of the vacuum cleaner.

A cyclone dust-collecting apparatus for a vacuum cleaner, includes: a cyclone body for separating filth from dirt-laden air drawn through an air-suction passage using centrifugal force; an air-discharging passage for discharging clean air; and a filth backflow-preventing member for shifting an advancing direction of the filth in the air from flowing to the air-discharging passage to a whirling air current along an inner side of the cyclone body.

The filth backflow-preventing member may be disposed at a lower part of a grill formed at a lower part of the air-discharging passage. The grill may prevent filth, such as hair, from being drawn into the air-discharging passage. The filth backflow-preventing member may have a sloping side declined about 5° to about 60° towards the suction direction of the air current. The filth backflow-preventing member may be spaced from a side of the cyclone body by about 10 mm to about 20 mm.

### BRIEF DESCRIPTION OF THE DRAWINGS

Further advantages of the present invention will become apparent to those skilled in the art with the benefit of the following detailed description of embodiments and upon reference to the accompanying drawings in which:

FIG. 1 is a sectional view showing a conventional cyclone dust-collecting apparatus;

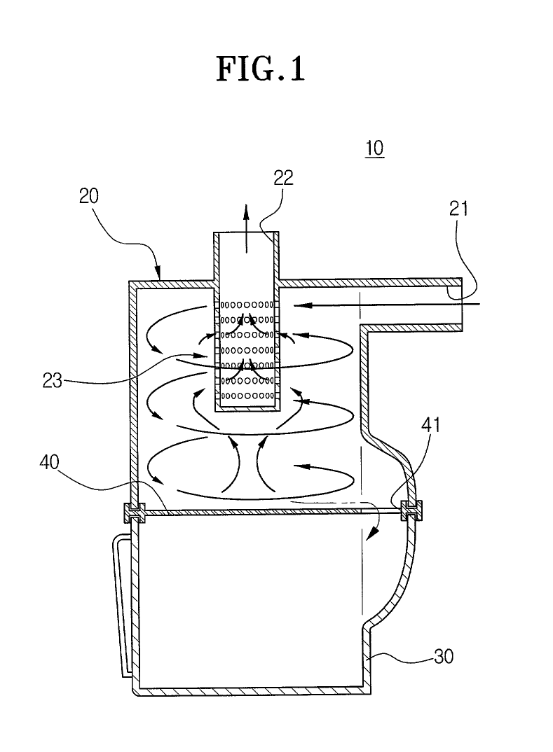

FIG. 2 is a sectional view of an embodiment showing a cyclone dust-collecting apparatus for a vacuum cleaner; and

FIG. 3 is a partial sectional view of an embodiment showing part of a cyclone dust-collecting apparatus for a vacuum cleaner.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

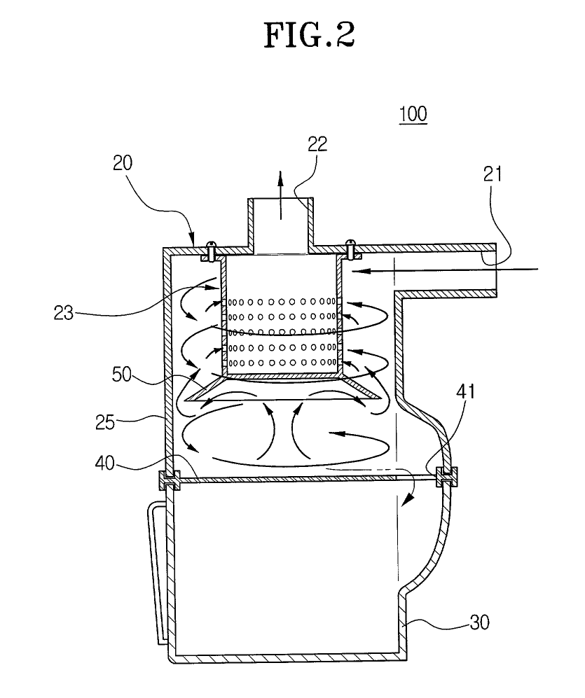

FIG. 2 shows an embodiment of a cyclone dust-collecting apparatus for a vacuum cleaner. According to FIG. 2, cyclone dust-collecting apparatus 100 may include cyclone body 20, filth-collecting portion 30, partition 40, and filth backflow-preventing member 50.

Air-suction passage 21 may be connected to a brush assembly (not shown) of the vacuum cleaner and may be disposed at an upper part of cyclone body 20. Air drawn through air-suction passage 21 may form a whirling air current in a tangential direction to cyclone body 20.

Air-discharging passage 22 may be connected to a vacuum-generating device (not shown) and may be disposed at an upper center of cyclone body 20. Grill 23 may be formed at a lower part of air-discharging passage 22 to prevent filth, such as hair, from being drawn into the vacuum-generating device.

Filth backflow-preventing member 50 maybe formed at a lower part of grill 23. Filth backflow-preventing member 50 may shift an advancing direction of filth in the air current flowing to grill 23 to a whirling air current along an inside of cyclone body 20. Filth backflow-preventing member 50 may include a plate which extends toward side 25 of cyclone body 20. The direction of the filth may be changed by being reflected off the plate.

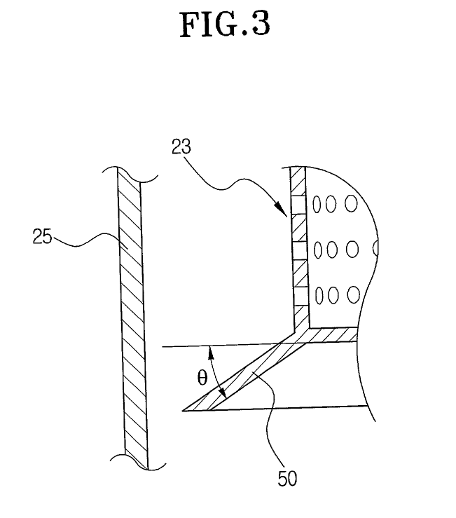

As shown in FIG. 3, an angle θ may be defined between filth backflow-preventing member 50 and an extension line of a lower side of grill 23. The function of filth backflow-preventing member 50 may be more easily performed if θ is small and filth backflow-preventing member 50 is close to side 25 of cyclone body 20. Filth backflow-preventing member 50 may decline about 50° to about 60° towards a suction direction of the air current. The distance between side 25 of cyclone body 20 and a front end of the filth backflow-preventing member may be about 10 mm to about 20 mm. If the front end of filth backflow preventing member 50 is too close to side 25, the whirling air current, drawn in through air-suction passage 21, may be hindered.

As shown in FIG. 2, filth-collecting portion 30 may be removably formed at a lower part of cyclone body 20 for easy removal of filth that is separated by cyclone body 20 and collected therein. Partition 40 may be disposed between cyclone body 20 and filth-collecting portion 30. Filth-discharging passage 41 may be formed at one side of partition 40 for permitting the filth separated by cyclone body 20 to pass through.

When the vacuum-generating device of a vacuum cleaner is operated, air and filth existing on a cleaning surface is drawn through a brush assembly and air-suction passage 21 into cyclone body 20. The air drawn into cyclone body 20 forms a whirling air current. The filth in the air may be separated by centrifugal force of the whirling air current. The filth may be collected in filth-collecting portion 30 through filth-discharging passage 41. The cleaned air may be discharged through grill 23 and air-discharging passage 22.

Filth that has not been separated from the air may flow to grill 23 along an air current. The filth included in the air current may hit filth backflow-preventing member 50 and be reflected. Thus, the direction of the filth may be shifted back to the whirling air current.

Accordingly, the filth may be whirled again in the whirling air current and may be separated from the air current by centrifugal force. After being separated, the filth may be collected in filth-collecting portion 30 through filth-discharging passage 41. Therefore, the amount of filth that flows to the vacuum-generating device of the vacuum cleaner through air-discharging passage 22 may substantially decrease and the dustcollecting function of the vacuum cleaner may substantially improve.

Cyclone body 20 and filth-collecting portion 30, separated by partition 40, may be applied to any type of cyclone dust-collecting apparatus.

Filth backflow-preventing member 50 may be any type of filth backflow-preventing member 50 able to reflect the filth.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A cyclone dust-collecting apparatus for a vacuum cleaner, comprising:
a cyclone body configured to separate filth from dirt-laden air drawn through an air-suction passage using a centrifugal force, and further configured to discharge clean air through an air-discharging passage; and
a filth backflow-preventing member configured to shift an advancing direction of filth included in the dirt-laden air from flowing to the air-discharging passage to a whirling air current along an inner side of the cyclone body.

2. The cyclone dust-collecting apparatus for a vacuum cleaner of claim 1, wherein the filth backflow-preventing member is disposed at a lower part of a grill, and wherein the grill is formed at a lower part of the air-discharging passage for preventing filth from being drawn therein.

3. The cyclone dust-collecting apparatus for a vacuum cleaner of claim 1, wherein the filth backflow-preventing member comprises a sloping side declined about 5° to about 60° towards a suction direction of the air current.

4. The cyclone dust-collecting apparatus for a vacuum cleaner of claim 1, wherein the filth backflow-preventing member is further configured to extend to the inner side of the cyclone body.

5. The cyclone dust-collecting apparatus for a vacuum cleaner of claim 1, wherein a distance between a front end of the filth backflow-preventing member and the inner side of the cyclone body is about 10 mm to about 20 mm.
